(19) United States
(12) Patent Application Publication
(10) Pub. No.: US 2008/0141948 A1
(43) Pub. Date: Jun. 19, 2008

(54) PET TOY WITH PALATABILITY ENHANCER

(75) Inventors: Jack W. Renforth, Aurora, CO (US); Neil Werde, Broomfield, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/611,678

(22) Filed: Dec. 15, 2006

(51) Int. Cl. A01K 29/00

(52) U.S. Cl. 119/710

(57) ABSTRACT

A pet toy formed from a base material such as rubber and palatability enhancer distributed within or on the base material. The pet toy may also include a masking scent such as vanilla or mint distributed within or on the base material. The masking scent masks potentially odors emitted by the pet toy to attract a domesticated animal such as a dog or a cat to the toy. The pet toy may further include substances such as dental cleaning agents, flavoring agents, colorants, and breath-freshening agents. The pet toy may include a body defining a chamber and holes providing access to the chamber. Pet treats may be placed into the chamber via the holes.

### FIELD OF THE INVENTION

The present invention generally relates to pet toys, and more particularly to pet toys that attract an animal to the toy and maintain the animal's interest in it.

### BACKGROUND OF THE INVENTION

Pet owners often use pet toys to allow their pets, such as dogs or cats, to engage in natural, yet potentially destructive behaviors such as biting and chewing. For example, when the pet is chewing on a valuable item, the owner may substitute the pet toy for the item, thus allowing the animal to continue to chew on the pet toy while preserving the valuable item from damage or destruction from the animal's chewing. However, after substituting the toy for the item, the animal may become bored with or otherwise not interested in the toy and return to chewing on a previous item. Thus, to attract the animal to the pet toy, pet toy manufacturers may embed a scent within the material. Although the scent may initially attract the animal, the animal may quickly lose interest as the scent fades. Also, some scents attractive to animals may be offensive to humans.

Another way to attract an animal to a toy is putting food (or a treat) into the toy. The food not only attracts the animal to the toy, but also retains the animal's interest as the animal will generally try to remove the food from the toy. Although this may solve the problem of keeping the animal interested in the toy, the animal may quickly lose interest in it once the animal consumes the food. Furthermore, if the pet owner continues to place food in the toy to keep the animal attracted to it, the animal may eat too much food per day which may result in obesity or other health issues for the animal.

Accordingly, what is needed in the art is an improved pet toy.

### BRIEF SUMMARY OF THE INVENTION

One embodiment of the present invention takes the form of a pet toy including a base material, a palatability enhancer, and a masking scent. The palatability enhancer is combined within the base material. The masking material is combined with at least one of the base material and palatability enhancer and emits an odor.

Another embodiment of the present invention takes the form of a method for creating a pet toy. The method includes mixing a palatability enhancer, a masking, and a partially non-solidified base material to form a formulation. The method yet further includes solidifying the formulation.

Yet another embodiment of the present invention takes the form of a pet toy and includes a base material and a palatability enhancer. The base material is at least partially composed of rubber. The palatability enhancer is distributed within the base material.

### BRIEF DESCRIPTION OF THE DRAWINGS

FIG. 1 depicts a top perspective view of a first example of a pet toy shape.

FIG. 2 depicts a bottom perspective view of the first example of a pet toy shape.

FIG. 3 depicts a top perspective view of a second example of a pet toy shape.

FIG. 4 depicts a bottom perspective view of the second example of a pet toy shape.

FIG. 5 depicts a top perspective view of a third example of a pet toy shape.

FIG. 6 depicts a bottom perspective view of the third example of a pet toy shape.

FIG. 7 depicts a flowchart for manufacturing a pet toy in accordance with a first embodiment of the present invention.

### DETAILED DESCRIPTION OF THE INVENTION

One embodiment of the present invention takes the form of a toy for use by a pet such as a dog, a cat, or other domesticated animal. The pet toy includes a base material and a palatability enhancer. The pet toy may further include a scent that may mask the potentially unpleasant odors emitted from the pet toy. The scent may be different from the flavor of the palatability enhancer. The pet toy may additionally include dental cleaning agents, flavoring agents, colorants, and/or breath freshening agents. As described in more detail below, the base material may be formed into a predetermined shape. The predetermined shape may include a body defining a chamber in communication with an environment external to the body via one or more holes defined by the body. A pet treat, rope, or other accessory may be received in the chamber, the holes, or both.

The base material may be any material generally safe for use (i.e., chewing) by an animal such as a dog, cat, or the like. In some embodiments, the base material may be a flexible plastic or rubber material or any other material that provides both flexibility and durability when chewed or bitten by an animal. In other embodiments, the base may be a more rigid plastic or rubber material, nylon, or other material that provides durability with minimal flexibility. In yet other embodiments, the base material may be a generally edible material such as rawhide or the like.

The palatability enhancer may be embedded within or coated on the base material. It may be uniformly distributed throughout or on the base material or concentrated in one or more areas within or on the base material. A more uniform distribution may be used to attract the animal equally to any portion of the pet toy. Concentrating the palatability enhancer in one or more predetermined regions may focus the animal's attention on specific portions of the toy.

The palatability enhancer may be any substance that generally triggers a chemical reaction in an animal that causes it to continue to chew, lick, eat, or otherwise play with the pet toy. The palatability enhancer may also emit an odor that initially attracts the animal to the pet toy. Palatability enhancers may be made wholly or partially from meat or poultry broth concentrate or spray-dried powder, hydrolyzed proteins, yeast and/or yeast extract, liver, or any combination such ingredients. One suitable palatability enhancer is 6C2 enhancer, supplied by Applied Food Biotechnology International, Inc. of St. Charles, Mo.

The pet toy may incorporate scents attractive to animals to initially attract the animal to the pet toy. Such scents may be noticeable by, and less pleasing to, humans. One such exemplary scent is Givaudan 96625332 Spearmint. Palatability enhancers may also emit odors attractive to animals but less pleasing to humans. To hide such odors from detection, the pet toy may further include a masking scent such as vanilla, mint, or the like. The masking scent may be sufficiently concentrated to mask the odor from detection by humans while not masking the odor from animals, which generally have a keener sense of smell. In other words, the odor remains detectable to the animal to attract the animal to the pet toy but masked from detection by humans by a second odor.

Like the palatability enhancer, the masking scent may be embedded within or coated on the base material. The masking scent may be uniformly distributed throughout or on the base material or concentrated in one or more areas within or on the base material. A more uniform distribution may be used to maintain the masking scent within the pet toy as the animal consumes the pet toy or separates it into multiple, independent portions.

The pet toy may include other optional substances such as dental cleaning agents, flavoring agents, colorants, breath freshening agents, and the like embedded within or coated on the base material. For example, a phosphate may be a suitable dental cleaning agent. Similarly, suitable breath-freshening agents may include parsley, kelp, or some combination thereof. Likewise, suitable flavoring agents may include garlic, meat flavoring (such as juices, pastes or powders), cheese flavors, fruit flavors, smoke flavors, or any combination thereof. Suitable colorants may include natural or synthetic dyes or pigments.

The base material may form the pet toy in its entirety or may be one of multiple pet toy materials. Moreover, the base material may be formed into any suitable shape to create a whole or partial pet toy. When the base material forms a portion of the pet toy, it may be joined to other materials using adhesives, sonic or heat welding, mechanical fasteners, any other suitable joining method, or any combination thereof.

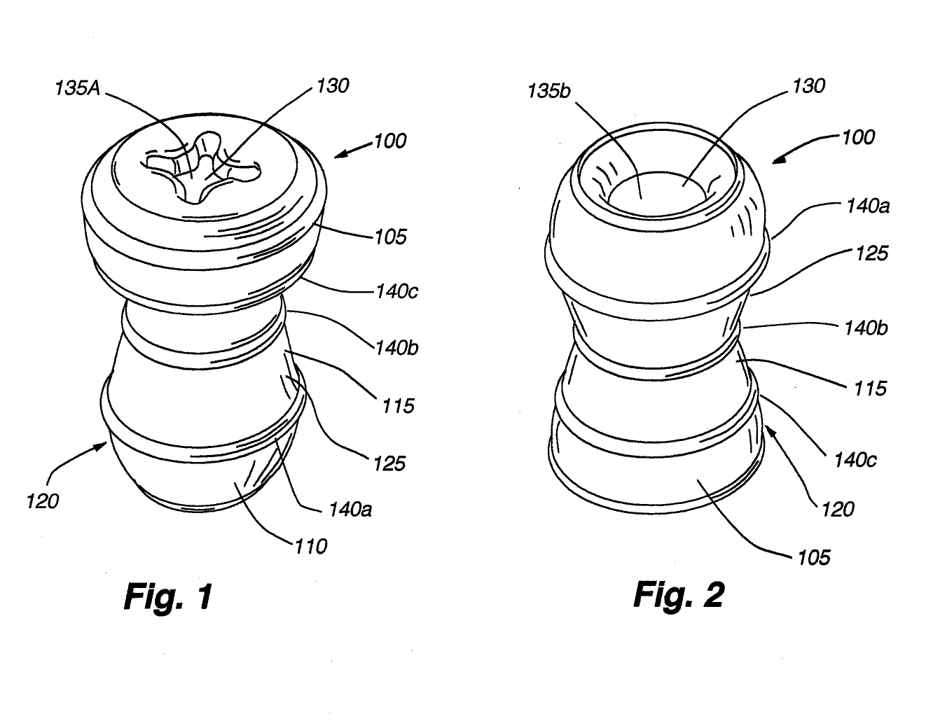

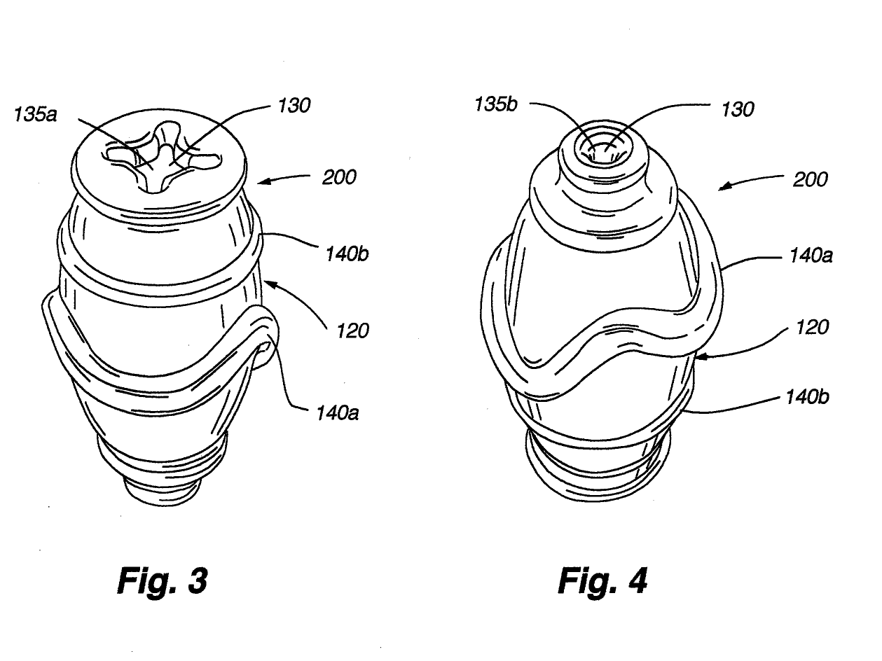

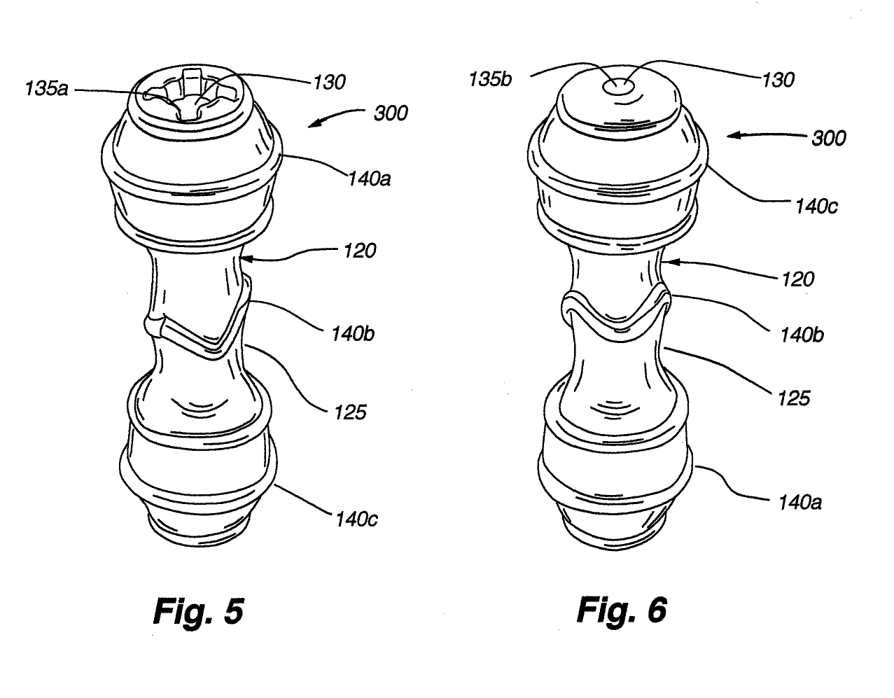

FIGS. 1-6 depict perspective views of various shapes for exemplary embodiments of pet toys formed using the base material with like reference numbers used for similar elements. The pet toy 100 depicted in FIGS. 1 and 2 includes a generally cylindrical end 105 joined to a generally bulbous end 110 by a necking region 115. The pet toy 200 shown in FIGS. 3 and 4 generally resembles a fire hydrant, and the pet toy 300 depicted in FIGS. 5 and 6 generally resembles a dumbbell.

As shown in FIGS. 1-6, the base material may be shaped into a body 120 including a sidewall 125 defining a chamber 130 therein. The chamber 130 may be spherical, cylindrical, conical, or any other shape. The sidewall's thickness may be selected to provide sufficient flexibility to allow the body to deform inwardly towards the chamber 130 when an animal bites the pet toy, yet sufficiently thick to minimize the potential for the animal to puncture the body with its teeth. The thickness of a sidewall 125 with such characteristics may depend upon the base material's properties and the body's shape. For example, when the base material is rubber and the body 120 defines a chamber, the sidewall's thickness may be between approximately ½″ and ⅜″.

The thickness of the body 120 and/or sidewall 125 may be uniform or may vary. As further shown in FIGS. 1-6, the body 120 may define one or more holes 135a-b providing communication between the chamber 130 and external environment. The holes 135a-b may be circular (as shown in FIGS. 2, 4 and 6), cruciform shaped (as shown in FIGS. 1, 3 and 5), or any other desired shape. The holes 135a-b may be located at end portions of the pet toy as generally depicted in the figures, or at any other location on the body 120.

The holes 135a-b may be sized to hold pet treats or other snacks for the animal. The body 120 around the holes 135a-b may be sufficiently flexible to enable the holes 135a-b to expand in order to receive and/or release a pet treat. Pet treats may be placed in the chamber 130 through the holes 135a-b for later removal by the animal as it plays with the pet toy.

The holes 135a-b may also receive a rope or the like, which may be knotted to be retained within the chamber 130. The rope may be used to play with the animal, provide flossing or other dental care for the animal, or to provide an object for a person to hold to avoid touching the pet toy or when throwing the toy for retrieval by the animal.

Other objects may be received within the chamber 130 through the holes 135a-b. For example, objects that make noise when the toy is moved may be inserted into the chamber 130 to further attract the animal to the toy. As yet another example, a buoyant material, such as an open celled foam or the like, may be inserted into the chamber 130 to increase the buoyancy of the pet toy.

As shown in FIGS. 1-6, the pet toy may include one or more ridges 140a-c or other projections about the exterior of the body 120. The ridges 140a-c may be decorative or may provide a dental cleaning or gum massaging surface for the animal when it bites the toy. If desired, the pet toy may also include grooves or other recesses (not shown). Like the ridges 140a-b, the grooves or other recesses may be merely decorative or may provide dental cleaning or gum massaging functions. The grooves or other recesses may also receive and retain pet treats or other food.

Although potential shapes of the pet toy are described above and depicted in FIGS. 1-6 with certain specificity, the pet toy may be formed into any desired shape. Moreover, the pet toy may have a hollow interior, as shown in the figures, or may have a solid interior. Further, the afore-described holes, grooves, recesses and/or projections are entirely optional.

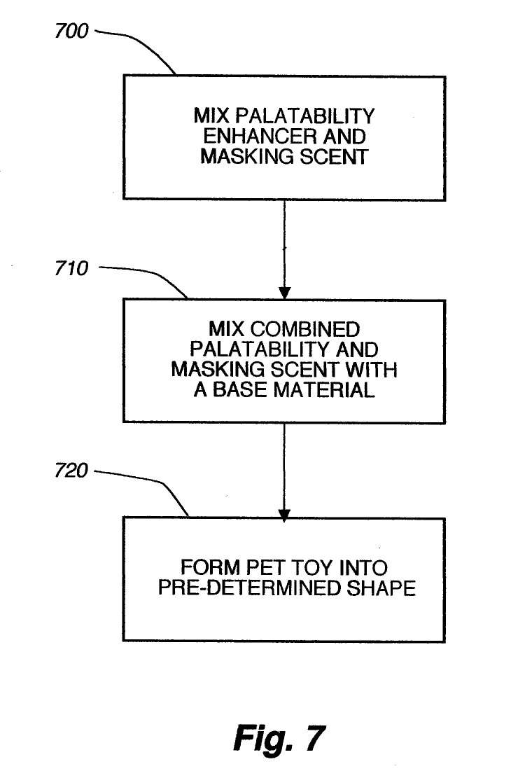

Turning to FIG. 7, one process for manufacturing an exemplary embodiment of the present invention is shown. In operation 700, the palatability enhancer and the masking scent are mixed together to form a first formulation. Additional, optional substances, such as dental cleaning agents, colorants, breath freshening agents, and the like, may also be mixed into this first formulation. In one embodiment, the palatability enhancer may be 6C2 enhancer, the masking scent may be vanilla, and the ratio of the palatability enhancer to the masking scent by weight may be 19:1. Other embodiments may utilize a different palatability enhancer, masking scent, and/or ratio of the palatability enhancer to the masking scent. Further, in some embodiments, the palatability enhancer or the masking scent may be omitted. If either of the palatability enhancer or the masking scent are omitted, the mixing operation may be skipped.

In operation 710, the first formulation may be mixed with a non-solidified base material such as wholly or partially liquefied rubber or other suitable, non-solidified base material to form a second formulation. The ratio of the base material to the first formulation may be 49:1 by weight (i.e., approximately 98% base material, 1.9% palatability enhancer, and 0.1% masking scent). Other embodiments may utilize a greater or lesser ratio of the base material to the first formulation. The second formulation may be formed and cured in operation 720 into a predetermined shape for the pet toy by injection molding, casting, or any other suitable method.

Although the operations for creating a pet toy are described as occurring in a certain order, the order of mixing the palatability enhancer, the masking scent, the base material, and other optional ingredients may be changed. For example, the palatability enhancer may be mixed with the base material to form a first formulation. Continuing with the example, the masking scent may be mixed with the first formulation to form the second formulation. Further, any or all of the palatability enhancer, the masking scent, and other optional substances may be coated on, adhered to, or otherwise joined with the base material after solidification of the base material.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present invention, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A pet toy comprising:
a base material;
a palatability enhancer combined with the base material; and
a masking scent combined with at least one of the base material and the palatability enhancer and emitting a first odor.

2. The pet toy of claim 1, wherein the palatability enhancer is substantially uniformly distributed throughout the base material.

3. The pet toy of claim 1, wherein the masking scent is substantially uniformly distributed throughout the base material.

4. The pet toy of claim 1, further comprising at least one substance emitting a second odor attractive to an animal.

5. The pet toy of claim 4, wherein the masking scent masks the second odor.

6. The pet toy of claim 1, wherein the palatability enhancer omits a second odor and the masking scent masks the second odor.

7. The pet toy of claim 1, wherein the ratio of the palatability enhancer to the masking scent is at least approximately 19 to 1 by weight.

8. The pet toy of claim 1, wherein the ratio of the base material to the palatability enhancer is at least approximately 54 to 1 by weight.

9. The pet toy of claim 1, wherein the ratio of the base material to the masking scent is at least approximately 980 to 1 by weight.

10. The pet toy of claim 1, wherein the masking scent is vanilla.

11. The pet toy of claim 1, wherein the base material forms a body defining a chamber.

12. The pet toy of claim 1, wherein the body further defines at least one hole in communication with the chamber.

13. The pet toy of claim 1, wherein the base material is at least partially composed of rubber.

14. A method of creating a pet toy comprising:
mixing a palatability enhancer, a masking scent, and a partially non-solidified base material to form a formulation; and
solidifying the formulation.

15. The method of claim 14, further comprising mixing together the palatability and the masking scent prior to mixing the palatability enhancer and the masking scent with the base material.

16. The method of claim 14, further comprising causing the formulation to solidify into a predetermined shape.

17. The method of claim 16, wherein the predetermined shape includes a body defining an interior chamber.

18. The method of claim 17, wherein the predetermined shape further includes the body defining at least one hole in communication with the chamber.

19. A pet toy comprising:
a base material at least partially composed of rubber; and
a palatability enhancer distributed within the base material.

20. The pet toy of claim 19, wherein the base material defines a predetermined shape.

21. The pet toy of claim 20, wherein the predetermined shape includes a body defining a chamber.

22. The pet toy of claim 21, wherein the body further defines at least one hole in communication with the chamber.

23. The pet toy of claim 19, further comprising a masking scent distributed within the base material.

24. The pet toy of claim 23, wherein the palatability enhancer omits an odor and the masking scent masks the odor emitted by the palatability enhancer.
